(19) United States
(12) Patent Application Publication
(10) Pub. No.: US 2014/0153498 A1
(43) Pub. Date: Jun. 5, 2014

(54) Filtering

(71) Applicant: Broadcom Corporation, Irvine, CA (US)

(72) Inventors: Seppo ROUSU, Oulu (FI); Jouni Kristian KAUKOVUORI, Vantaa (FI); Antti Oskari IMMONEN, Helsinki (FI)

(73) Assignee: Broadcom Corporation, Irvine, CA (US)

(21) Appl. No.: 13/780,286

(22) Filed: Feb. 28, 2013

(30) Foreign Application Priority Data
Mar. 19, 2012 (GB) 12047981.1

(51) Int. Cl. H04W 72/04; H04L 5/00

(52) U.S. Cl. CPC H04W 72/048; H04L 5/0073
USPC 370/329

(57) ABSTRACT

Methods, apparatuses, computer software and computer program products for indicating filtering capabilities of user equipment. Information associated with filtering capabilities of the user equipment is transmitted from the user equipment to a communication counterpart.

### CROSS REFERENCE TO RELATED APPLICATION

This application claims the benefit under 35 U.S.C. §119(a) and 37 CFR §1.55 to UK patent application no. GB1204798.1, filed on 19 Mar. 2012, the entire content of which is incorporated herein by reference.

### TECHNICAL FIELD

The present disclosure relates to an indication of filtering capabilities of user equipment, in particular, but not exclusively, the present disclosure relates to methods, apparatuses, computer software and computer program products for indicating filtering capabilities of user equipment.

### BACKGROUND

Currently in 3GPP, several new bands are under standardization. Radio frequency (Rb) filtering is a critical block, when RF performances both for uplink (UL) and downlink (DL) are defined for each new frequency domain duplexing (FDD) band and time domain duplexing (TDD) band. When the bandwidth of the filter becomes relatively wide compared to the center frequency and/or the duplex gap between transmitter (TX) and receiver (RX) is narrow, achieving proper filtering performance becomes a challenging task. A normalized prototype filter will require more and more stages thus leading to snore complicated filter design. Typically, environmental temperature changes of RF components are specified and for filters especially, temperature drift should be taken into account. When the filter order increases, the insertion loss (IL) or pass-hand ripple will increase which means that higher receiver noise figure (NF) or higher power dissipation is needed in the transmitter side to compensate for the output power loss. FIG. 1A shows an illustration of a narrow band filter having a relatively wide duplex distance and FIG. 1B shows an illustration of a wider-bandwidth filter with a relatively narrow duplex distance.

Some of the bands have such a frequency arrangement that they may require two or even more sub-band filters to cover a single cellular band, as illustrated in FIG. 2. As a result, better IL with sufficient RX/TX isolation is achieved even after taking into account additional switch(es) that a front-end requires. In some FDD radio communication frequency allocations, down link have lower frequency range than uplink (not shown in figure), for example, E-UTRA operating bands B20 and B13.

In future, filter technology will further evolve and thus allow design of band-filters that cover the whole band with sufficient performance making sub-band filters obsolete. On the other hand, radio system allocations and thus emissions in different geographical areas will change over time and may create new performance challenges.

The problem that the present disclosure addresses is that a network entity such as an evolved Node (eNB) does not know whether a certain band in a user equipment (UE) is equipped with a single band filter or a band filter that consists of overlapping sub-band filters.

In APAC700 (allocated in UL: 703-748 MHz, DL: 758-803 MHz, this band is currently under standardization by 3GPP and will have 3GPP band number 28) the assumed band filter implementation consists of sub-band filters. 3GPP specifications do not force the use of filters consisting of sub-band filters but some of the co-existence requirements are devised under the assumption of sub-band filters being employed. In some countries such as Japan, Digital TV is allocated at lower sub-band frequency (up to 710 MHz) preventing the use of frequencies at lower sub-band filters. In future, when filter technology evolves, single band filters are expected to be employed. An eNB would thus benefit from information on the filter characteristics/filtering capabilities, because in the case of sub-band filters being employed, it can freely allocate Resource Blocks (RBs) at higher sub-band filter frequencies, but in the case of a single band filter being employed, it can only allocate RBs to the highest part of the single-band filter. In the case of a single filter there is no attenuation provided by the filter to protect Digital TV, thus RBs need to be allocated far enough away from Digital TV in order to avoid the APAC700 emissions violating Digital TV emission limits. The band filtering alternatives and possible RB allocation ranges are shown in FIGS. 3A and 3B, respectively. With a sub-band filter solution, a greater number of RBs can be allocated as depicted in FIGS. 3A and 3B. Further, with better filtering, the aliasing of LTE spectrum over TV signal is mitigated.

Additionally, a challenging Frequency Division Duplex (FDD) band (Band 22) exists around the vicinity of 3.5 GHz. In B22, the center RF frequency is high, the frequency gap between the RX and TX is narrow (20 MHz), and TX and RX bandwidths are relatively wide (80 KHz). It is expected that filters supporting this band will also consist of sub-filters. A similar kind of sub-filter implementation may be needed for TDD radio communication systems around the vicinity of 3.5 GHz, with 200 MHz BW. These E-UTRA operating band numbers are 842 (3400-3600 MHz) and B43 (3600-3800 MHz).

Yet another example is a band called AXGP (TDD) (Advanced eXtended Global Platform, allocated at 2545-2575 MHz), which is a subset of Band 41 (TDD). B41 is one of the most challenging bands and there are proposals to use three sub-filters to cover the whole band. Then, consider that initially UEs having capability to support AXGP part only are available on the market. Later on, when B41 networks are fully deployed, AXGP-only UEs might not get access to B41 network since only part of the band can be supported.

Further examples can be found from areas outside 3GPP. For example, Wimax Release 1 has support for bands in frequency area 2300-2400 MHz (also near WLAN), 2490-2690 MHz, and 3400-3600 MHz. In addition, in CDMA2000, there are some bands near the 2.4-GHz ISM (Industrial, Scientific and Medical) Band. Thus, also devices implementing these technologies may benefit from using sub-band filtering and a similar type of filtering capability information sharing as in this 3GPP example.

Another example is described with respect to FDD bands 2 and 25, where band 25 is 5 MHz larger at the high frequency end. Examples for transmission and reception bandwidth are shown in table 1 below.

TABLE 1
Examples for transmission and reception bandwidth for band 2 and 25

| Band | TX | RX |
|---|---|---|
| 2 | 1850-1910 | 1930-1990 |
| 25 | 1850-1915 | 1930-1995 |

One implementation could be using to use 2 split band filters, possibly with predefined overlap frequencies between the filters.

A second implementation could be that the band 2 filters are frequency tunable upwards when B25 is operational or when the highest channels of band 25 are required. However, there is a problem that with B25 the lowest 5 MHz cannot be covered concurrently with the highest 5 MHz, e.g. for network measurements, network positioning measurements, intra carrier aggregations.

The present disclosure relates to facilitating mitigation of some In-Device co-existence problems. For instance, in the case of B40 LTE+WLAN radio use case, there is only a 3 MHz gap between B40 upper edge and the WLAN channel 1 lower edge. With current filter technology, is it not possible to achieve proper attenuation and thus, B40 UL will cause &sense to WLAN DL, and WLAN UL will cause desense to B40 DL. Ways to avoid/mitigate desense are to allocate RB's in such a way that they are far enough away from WLAN channels and/or to use only higher WLAN channels (further away from the B40 upper edge) or to make B40 with sub-band filters. The problem here is that currently an eNB does not know if there is a single B40 filter (limited RB allocation) or multiple sub-band filters (free RB allocation at lower sub-band filter frequency). Using higher WLAN channel arrangements is also difficult, because WLAN counterpart systems may be set to operate at lowest channels. Using scheduling in the time domain to solve the above interoperability problem may reduce customer satisfaction because it reduces data throughput of radio link/s. Using a scheduling arrangement is also problematic, because WLAN counterpart systems may not support scheduling features.

Currently, a UE reports only supported bands; no information on band filtering capabilities is signaled.

If an eNB could have knowledge about a UE's filtering capabilities, it could allocate RB's more freely and also lower WLAN channels could be used.

### REFERENCES

[1] R4-115926, “Dual duplexer configuration and channel bandwidth for APAC700 (FDD)”; 3GPP TSG-RAN WG4 #61; San Francisco, US; Nov. 14-18, 2011
[2] R4-15914, “APAC700 MHz UE dual duplexer design and 20 MHz support”; 3GPP TSG RAN Working Group 4 (Radio) meeting #61; San Francisco, USA, Nov. 14-18, 2011
[3] R4-114681, “Requirements for Band 22”; 3GPP TSG-RAN WG4 #60; Athens, Greece; Aug. 27-26, 2011;
[4] 3GPP TS 36.306; 3rd Generation Partnership Project; Technical Specification Group Radio Access Network; Evolved Universal Terrestrial Radio Access (E-UTRA); User Equipment (UE) radio access capabilities; (Release 10) V10.3.0; September 2011
[5] 3GPP TS 36.331; 3rd Generation Partnership Project; Technical Specification Group Radio Access Network; Evolved Universal Terrestrial Radio Access (E-UTRA); Radio Resource Control (RRC); Protocol specification (Release 10); V10.4.0, December 2011.

### SUMMARY

According to first embodiments, there is a method of controlling a user equipment, the method comprising, at the user equipment, transmitting, to a communication counterpart, information associated with band filtering capabilities of the user equipment,

wherein the transmitted information is for use in allocating radio resources for the user equipment.

According to second embodiments, there is a method of controlling a network entity, the method comprising, at the network entity:

receiving, from a user equipment, information associated with band filtering capabilities of the user equipment; and

utilizing the information associated with band filtering capabilities in allocating radio resources for the user equipment.

According to third embodiments, there is apparatus for use in controlling a user equipment, the apparatus comprising a processing system adapted to cause the apparatus to transmit information associated with band filtering capabilities of the user equipment to a communication counterpart,

wherein the transmitted information is for use in allocating radio resources for the user equipment.

According to fourth embodiments, there is apparatus for use in controlling a network entity, the apparatus comprising a processing system adapted to cause the apparatus to:

receive, from a user equipment, information associated with band filtering capabilities of the user equipment: and

utilize the information associated with band filtering capabilities in allocating radio resources for the user equipment.

According to fifth embodiments, there is computer software adapted to perform the method of the first embodiments.

According to sixth embodiments, there is computer software adapted to perform the method of the second embodiments.

According to seventh embodiments, there is a computer program product comprising a non-transitory computer-readable storage medium having computer readable instructions stored thereon, the computer readable instructions being executable by a computerized device to cause the computerized device to perform a method of controlling a user equipment, the method comprising, at the user equipment, transmitting, to a communication counterpart, information associated with band filtering capabilities of the user equipment,

wherein the transmitted information is for use in allocating radio resources for the user equipment.

According to eighth embodiments, there is a computer program product comprising a non-transitory computer-readable storage medium having computer readable instructions stored thereon, the computer readable instructions being executable by a computerized device to cause the computerized device to perform a method of controlling a network entity, the method comprising, at the network entity:

receiving, from a user equipment, information associated with band filtering capabilities of the user equipment; and

utilizing the information associated with band filtering capabilities in allocating radio resources for the user equipment.

According to embodiments, there is a computer program product comprising computer-executable computer program code which, when the program is run on a computer (e.g. a computer of an apparatus according to any one of the aforementioned apparatus-related embodiments), is arranged to cause the computer to carry out the method according to any one of the aforementioned method-related embodiments.

Such computer program product may comprise or be embodied as a (tangible) computer-readable (storage) medium or the like on which the computer-executable computer program code is stored, and/or the program may be directly loadable into an internal memory of the computer or a processor thereof.

Further features and advantages will become apparent from the following description of preferred embodiments, given by way of example only, which is made with reference to the accompanying drawings.

### BRIEF DESCRIPTION OF THE DRAWINGS

FIGS. 1A and 1B show diagrams illustrating insertion loss in different TRX filter cases;

FIG. 2 shows a diagram illustrating insertion loss in a case where a wideband filter is replaced by two sub-band filters;

FIGS. 3A and 3B show diagrams illustrating band filtering alternatives and possible RB allocation ranges;

FIGS. 4A to 4D show diagrams illustrating some examples for possible filter structures;

FIG. 5 shows a principle flowchart of a method according to embodiments;

FIG. 6 shows a principle configuration of apparatus according to embodiments;

FIG. 7 shows a principle flowchart of a method according to embodiments; and

FIG. 8 shows a principle configuration of an apparatus according to embodiments.

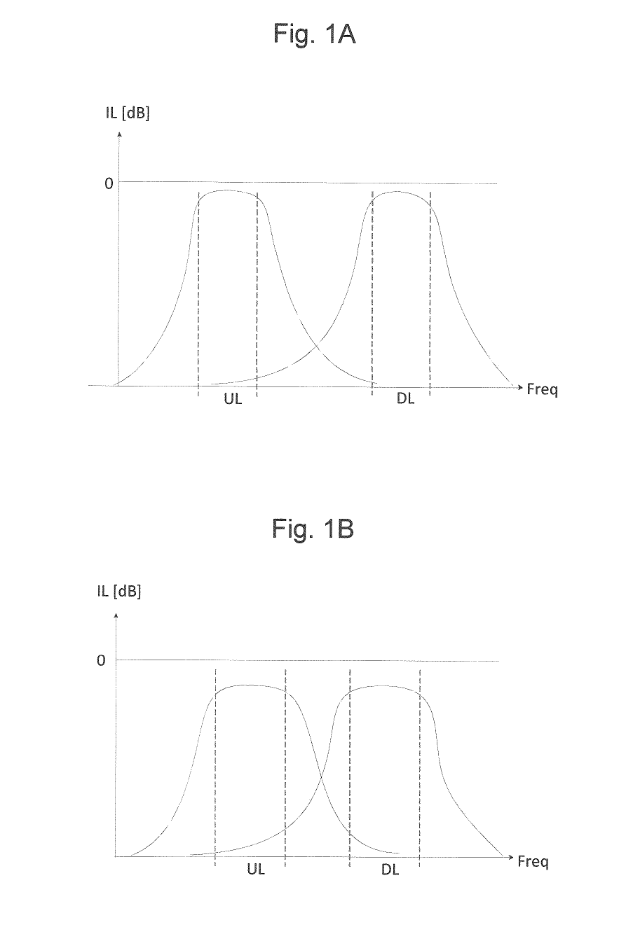

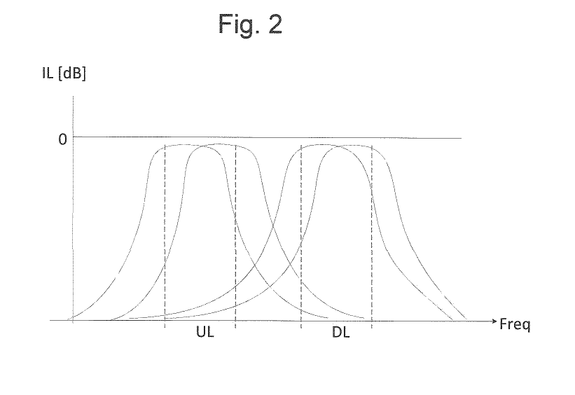

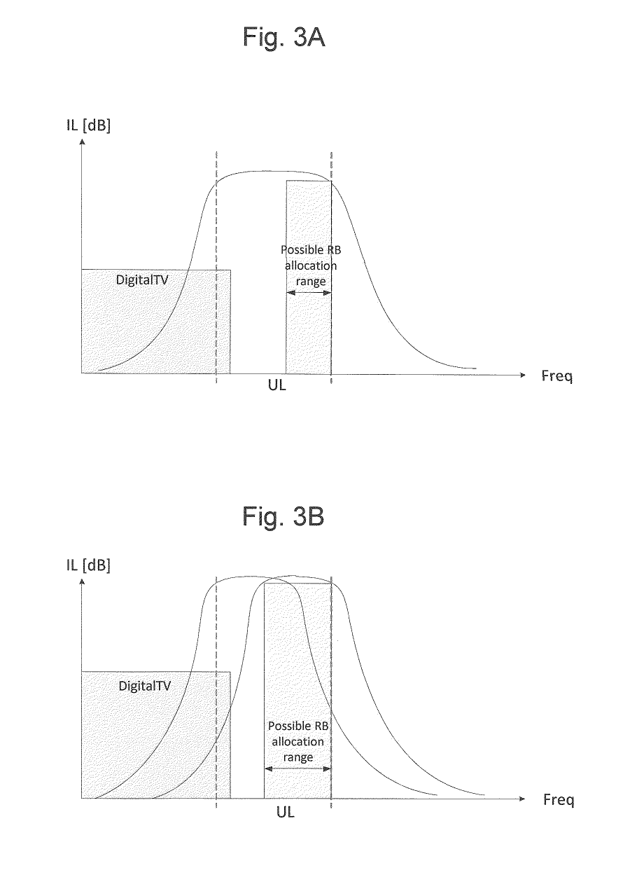

### DETAILED DESCRIPTION

Embodiments of the present disclosure will be described herein below. More specifically, embodiments are described hereinafter with reference to particular non-limiting examples. A person skilled in the art will appreciate that embodiments are by no means limited to these examples, and may be more broadly applied.

It is to be noted that the following description of embodiments mainly refers to specifications being used as non-limiting examples of configurations and deployments. Namely, embodiments are mainly described in relation to 3GPP specifications being used as non-limiting examples of network configurations and deployments. In particular, a HSPA, a LTE/LTE-Advanced communication system is used as a non-limiting example for the applicability of thus described embodiments. As such, the description of embodiments given herein specifically refers to terminology which is directly related thereto. Such terminology is only used in the context of the presented non-limiting examples, and naturally does not limit embodiments in any way. Rather, any other network configuration or system deployment, etc. may also be utilized as long as compliant with the features described herein.

Embodiments mainly relate to 3G and LTE and systems beyond LTE. More specifically this relates to bands, both FDD and TDD radio band allocations, that may contain band filters that are made of at least two sub-band filters.

Further, embodiments of the present application are also applicable to Wimax and CDMA2000. Namely, as already mentioned above, also devices implementing these technologies may benefit from using sub-band filtering, and similar types of filtering capability information sharing as described below with respect to 3GPP cases.

Hereinafter, various embodiments and implementations of the present disclosure and its aspects or embodiments are described using several alternatives. It is generally noted that, according to certain needs and constraints, all of the described alternatives may be provided alone or in any conceivable combination (also including combinations of individual features of the various alternatives).

According to embodiments of the present disclosure, in general terms, there are provided mechanisms, measures and means for indicating filtering capabilities of user equipment.

According to embodiments of the present disclosure, the problems as described above can be avoided, when the network or communication counterpart is informed about LTE filtering capabilities.

In this regard, it is noted that a communication counterpart in general may be an alternate device, e.g. in D2D communication. The communication counterpart may get UE filtering information directly from UE or via network from UE for communication establishment.

According to a first embodiment of the present disclosure, band filtering capabilities of a user equipment are signaled to an eNB.

The signaled capabilities include at least one of
Sub-band pass-band edge(s)
Sub-band center frequency
Sub band filter band width
Band filter covering whole band
Filter response tunability
Filter response tunability characteristics

According to a second embodiment of the present disclosure, the eNB transmits requests for more filter information when the LE signals some information. For example, if the UE signals some filtering capabilities, there may be the case that the eNB needs some other information and therefore asks for the information using signalling from the LE as a trigger.

According to the first embodiment, the signalling can be added to the user equipment's EUTRA-Capability signalling, for example the “RF-parameters” section of such signalling.

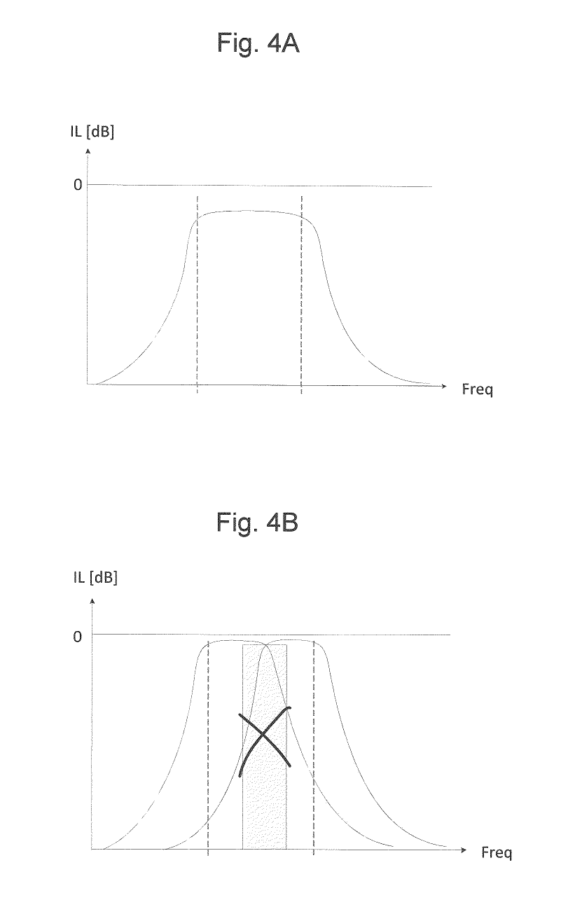

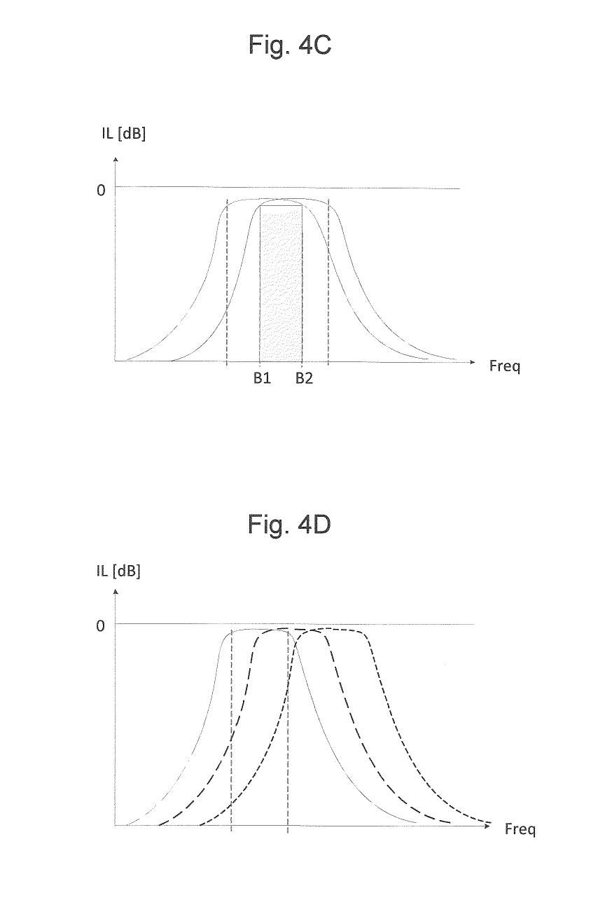

FIGS. 4A to 4D illustrate some examples for possible filter structures. It is noted that also case(s) where the filter consists of three (or even more) sub-band filters is possible.

In a first example case shown in FIG. 4A, the filter is a traditional one and covers the whole band. In this case, the UE can signal that the filter supports whole bands. However, it is also possible that the UE signals nothing (since UEs up to Release 10 are not able to signal anything, yet) and in such a case, a default is set that the filter covers the whole band. The eNB can thus understand that the filter covers the whole bands.

In a second example case shown in FIG. 4B, the filter consists of two (or more) sub-band filters. Although FIG. 4B illustrates only two sub-band filters, it is noted that embodiments are not limited thereto and any other suitable number of sub-band filters may be used. In the second example case, the UE signals frequencies B1 and B2, or some other parameters from which the sub-band filter pass-band edges can be calculated (for example sub-band filter pass-band bandwidth etc). In this regard, however, it is to be noted that the amount of overlap (B2−B1) sets the maximum carrier bandwidth that can be freely allocated. For instance, if B2−B1 is limited to 15 MHz, then a 20 MHz carrier cannot be allocated totally freely but should be allocated with some limitations.

As discussed in document [3], the pass-band overlap should be 20 MHz and 40 MHz in maximum single-carrier BW case and max Carrier Aggregation case, respectively, with current 3GPP Rel10/11 working assumption carrier BW's. However, it is noted that with future releases, other definitions of the pass-band overlap are possible. If both scenarios are taken into account, IL on both TX and RX chains is increased. If an eNB had the knowledge of the UE filtering capability, it could allocate different carrier aggregation (CA) component carriers between different filter chains. As a result, the filter overlap could be kept reasonable and IL could be minimized.

A third example case shown in FIG. 4C is a kind of modification to the second example case. In the third example case there is virtually no overlap in the sub-band filters (in practice, some overlapping is needed to compensate temperature drift). Carrier allocation is thus more limited. Around mid-band, wide carriers cannot be allocated because only one of the filters can be configured at a time. The benefit of this arrangement compared to the second example case is that the IL of the filters is minimized due to minimized BWs. Although this alternative may not desired by operators, this may be faced in certain bands.

In a fourth example case shown in FIG. 4D, the filter pass-band is tunable in the frequency domain. Depending on the use case, in-device co-existence issues with other non-cellular Radio Access Technology (RAT), or other radio frequency interference scenarios, it would be beneficial to adjust the filter edges. The UE could thus inform the frequency allocation which suits its situation best.

The Information Element (IE) UE-EUTRA-Capability is used to convey the E-UTRA UE Radio Access Capability Parameters, as described in document [4], and the Feature Group indicators for mandatory features (defined in Annex B.1 of document [5]) to the network. The IE UE-EUTRA-Capability is transferred in E-UTRA or in another RAT.

As described above, as a non-limiting example, the signalling can be added to the user equipment's EUTRA-Capability signalling, for example in the “RF-parameters” section. However, this is of course not to be understood as limiting embodiments thereto, but the signalling could also be added to any other suitable section. According to document [5], the Information Element UE-EUTRA-Capability is defined as follows:

UE-EUTRA-Capability information element

-- ASN1START

| | |
|---|---|
| UE-EUTRA-Capability ::= | SEQUENCE { |

| accessStratumRelease | AccessStratumRelease, | |
|---|---|---|
| ue-Category | INTEGER (1..5), | |
| pdcp-Parameters | PDCP-Parameters, | |
| phyLayerParameters | PhyLayerParameters, | |
| rf-Parameters | RF-Parameters, | |
| measParameters | MeasParameters, | |
| featureGroupIndicators | BIT STRING (SIZE (32)) | OPTIONAL, |

| | |
|---|---|
| interRAT-Parameters | SEQUENCE { |

| | |
|---|---|
| utraFDD | IRAT-ParametersUTRA-FDD |

OPTIONAL,

| | |
|---|---|
| utraTDD128 | IRAT-ParametersUTRA-TDD128 |

OPTIONAL,

| | |
|---|---|
| utraTDD384 | IRAT-ParametersUTRA-TDD384 |

OPTIONAL,

| | |
|---|---|
| utraTDD768 | IRAT-ParametersUTRA-TDD768 |

OPTIONAL,

| | |
|---|---|
| geran | IRAT-ParametersGERAN |

OPTIONAL,

| | |
|---|---|
| cdma2000-HRPD | IRAT-ParametersCDMA2000-HRPD |

OPTIONAL,

| | |
|---|---|
| cdma2000-1xRTT | IRAT-ParametersCDMA2000-1XRTT |

| OPTIONAL | | |
|---|---|---|
| }, | | |
| nonCriticalExtension | UE-EUTRA-Capability-v920-IEs | OPTIONAL} |

| | |
|---|---|
| UE-EUTRA-Capability-v920-IEs ::= | SEQUENCE { |

| | |
|---|---|
| phyLayerParameters-v920 | PhyLayerParameters-v920, |

| | |
|---|---|
| interRAT-ParametersGERAN-v920 | IRAT-ParametersGERAN-v920, |

| | | |
|---|---|---|
| interRAT-ParametersUTRA-v920 | IRAT-ParametersUTRA-v920 | OPTIONAL, |

| | |
|---|---|
| interRAT-ParametersCDMA2000-v920 | IRAT-ParametersCDMA2000-1XRTT-v920 |

| OPTIONAL, | |
|---|---|
| deviceType-r9 | ENUMERATED {noBenFromBatConsumpOpt} |
| OPTIONAL, | |
| csg-ProximityIndicationParameters-r9 CSG-ProximityIndicationParameters-f9, | |
| neighCellSI-AcquisitionParameters-r9 NeighCellSI-AcquisitionParameters-r9, | |
| son-Parameters-r9 | SON-Parameters-r9, |

| | | |
|---|---|---|
| nonCriticalExtension | UE-EUTRA-Capability-v940-IEs | OPTIONAL |

}

| UE-EUTRA-Capability-v940-IEs ::= | | SEQUENCE { | |
|---|---|---|---|
| | lateNonCriticalExtension | OCTET STRING | OPTIONAL, |
| | nonCriticalExtension | UE-EUTRA-Capability-v1020-IEs | OPTIONAL |

}

| | |
|---|---|
| UE-EUTRA-Capability-v1020-IEs ::= | SEQUENCE { |

| ue-Category-v1020 | INTEGER (6..8) | OPTIONAL, |
|---|---|---|
| phyLayerParameters-v1020 | PhyLayerParameters-v1020 | OPTIONAL, |
| rf-Parameters-v1020 | RF-Parameters-v1020 | |
| OPTIONAL, | | |
| measParameters-v1020 | MeasParameters-v1020 | OPTIONAL, |

| | | |
|---|---|---|
| featureGroupIndicators-v1020 | BIT STRING (SIZE (32)) | OPTIONAL, |

| interRAT-ParametersCDMA2000-v1020 | IRAT-ParametersCDMA2000-1XRTT-v1020 |
|---|---|
| OPTIONAL, | |
| ue-BasedNetwPerfMeasParameters-r10 | UE-BasedNetwPerfMeasParameters-r10 |
| OPTIONAL, | |
| interRAT-ParametersUTRA-TDD-v1020 | IRAT-ParametersUTRA-TDD-v1020 |

| OPTIONAL, | | |
|---|---|---|
| nonCriticalExtension | SEQUENCE { } | OPTIONAL |

}

| | |
|---|---|
| AccessStratumRelease ::= | ENUMERATED { |

rel8, rel9, rel10, spare5, spare4, spare3,
spare2, spare1, ...}

| | |
|---|---|
| PDCP-Parameters ::= | SEQUENCE { |

| | |
|---|---|
| supportedROHC-Profiles | SEQUENCE { |

| | |
|---|---|
| profile0x0001 | BOOLEAN, |
| profile0x0002 | BOOLEAN, |
| profile0x0003 | BOOLEAN, |
| profile0x0004 | BOOLEAN, |
| profile0x0006 | BOOLEAN, |
| profile0x0101 | BOOLEAN, |
| profile0x0102 | BOOLEAN, |
| profile0x0103 | BOOLEAN, |
| profile0x0104 | BOOLEAN }, |

| | |
|---|---|
| maxNumberROHC-ContextSessions | ENUMERATED { |

| cs2, cs4, cs8, cs12, cs16, cs24, cs32, | |
|---|---|
| cs48, cs64, cs128, cs256, cs512, cs1024, | |
| cs16384, spare2, spare1} | DEFAULT |

cs16,

...

}

| | |
|---|---|
| PhyLayerParameters ::= | SEQUENCE { |

| | |
|---|---|
| ue-TxAntennaSelectionSupported | BOOLEAN, |

| | |
|---|---|
| ue-SpecificRefSigsSupported | BOOLEAN |

| | |
|---|---|
| } | |
| PhyLayerParameters-v920 ::= | SEQUENCE { |

| | | |
|---|---|---|
| enhancedDualLayerFDD-r9 | ENUMERATED {supported} | OPTIONAL, |
| enhancedDualLayerTDD-r9 | ENUMERATED {supported} | OPTIONAL |

}

| | |
|---|---|
| PhyLayerParameters-v1020 ::= | SEQUENCE { |

| | |
|---|---|
| twoAntennaPortsForPUCCH-r10 | ENUMERATED {supported} |

| OPTIONAL, | |
|---|---|
| tm9-With-8Tx-FDD-r10 | ENUMERATED {supported} |
| OPTIONAL, | |
| pmi-Disabling-r10 | ENUMERATED {supported} |
| OPTIONAL, | |
| crossCarrierScheduling-r10 | ENUMERATED {supported} |

| OPTIONAL, | |
|---|---|
| simultaneousPUCCH-PUSCH-r10 | ENUMERATED {supported} |
| OPTIONAL, | |
| multiClusterPUSCH-WithinCC-r10 | ENUMERATED {supported} |

OPTIONAL,
nonContiguousUL-RA-WithinCC-List-r10 NonContiguousUL-RA-WithinCC-List-r10
OPTIONAL

}
NonContiguousUL-RA-WithinCC-List-r10 ::= SEQUENCE (SIZE (1..maxBands)) OF
NonContiguousUL-RA-WithinCC-r10

| | |
|---|---|
| NonContiguousUL-RA-WithinCC-r10 ::= | SEQUENCE { |

nonContiguousUL-RA-WithinCC-Info-r10 ENUMERATED {supported}
OPTIONAL

}

| | |
|---|---|
| RF-Parameters ::= | SEQUENCE { |

| | |
|---|---|
| supportedBandListEUTRA | SupportedBandListEUTRA |

}

| | |
|---|---|
| RF-Parameters-v1020 ::= | SEQUENCE { |

| | |
|---|---|
| supportedBandCombination-r10 | SupportedBandCombination-r10 |

}
SupportedBandCombination-r10 ::= SEQUENCE (SIZE (1..maxBandComb-r10)) OF
BandCombinationParameters-r10

According to the embodiments of the present disclosure, when the UE is able to indicate the sub-band capability, the AXGP case mentioned above can be resolved. If the UE can support the AXGP portion only, it could signal it to B41 network and get access albeit being able to support just a portion of the whole B41. Without the measures described in the present application, AXGP-UE could not be granted into the B41 network.

According to the second embodiment, the eNB receives signalling containing some filtering capabilities. This is used as a trigger for the eNB to request more information from the UE. A benefit of this kind of signalling would be that the UE does not have to signal all possible information every time.

According to a third embodiment, the fact that signalling of all the possible filter edges can cause significant overhead in the network is taken into account. Thus, it could be beneficial to define a set of sub-filters which can cover the band in a satisfactory manner. It would then be possible to signal only a predefined value which can indicate the UE filtering capability to the eNB.

Such a predefined value could be band-specific. That is, a predefined value given for B41 means different filter setup from a set given for B40, for example. That is, if MSS values 0 to 4 are sufficient to cover B41 needs, then the corresponding MSS values for B40 do not start from MSS=5 but MSS=0 to 4 could be reused. For B40 this means a completely different filter setup.

For example, in the above mentioned AXGP-B41 case, a proper filter could be located at 2496-2575 MHz only (the lowest third part of B41). Another filter set for B41 could be 2575-2620 MHz and 2620-2690 MHz, for example. Alternatively, AXGP-only band filter could be located at 2545-2575 MHz.

In an example below, a value called “Mobile Station Signalling” (MSS) is presented. If MSS=0, the whole band is supported (default). If MSS=1 is signaled, only AXGP portion is supported by UE. If MSS=2, the lowest had part is supported, if MSS=4, the uppermost third part is supported, etc.

TABLE 2
Example of Mobile Station Signalling (MSS) value definition vs.
filter coverage at Band 41.

| | Filter coverage | | | |
|---|---|---|---|---|
| | 2496-2545 | 2545-2575 | 2575-2620 | 2620-2690 |
| MSS = 0 | yes | Yes | yes | yes |
| MSS = 1 | no | Yes | no | no |
| MSS = 2 | yes | Yes | no | no |
| MSS = 3 | no | No | yes | no |
| MSS = 4 | no | No | no | yes |

In view of the above, the eNB knows what kind of filter is used in the UE. This assists the eNB in RB allocation. When narrower hand-filters are viable, cell coverage and UE power dissipation can be optimized since filter losses can be minimized. In general, the present disclosure allows reduced interferences to external receivers, e.g. APAC 700, WLAN, UL-MIMO as well as reduced interferences/blocking to own receivers, e.g. B40/WLAN.

In general, the present disclosure allows optimized resource block allocation in the case of roaming with sub-band filters—both in single carrier cases and CA cases.

Currently, UEs comprising sub-band filters only have access to “main” band (e.g. AXGP vs. B41). According to embodiments, this situation could be avoided, as described above.

Further, unnecessary use of NS class communication can be avoided. An eNB decides the required spectrum mask and NS-value. With improved filtering performance there might be cases where NS values are not needed. If the eNB had the knowledge of the UE filtering capability, it could allocate RBs based on that information. With less A-MPR and lesser IL, improved cell coverage is achieved.

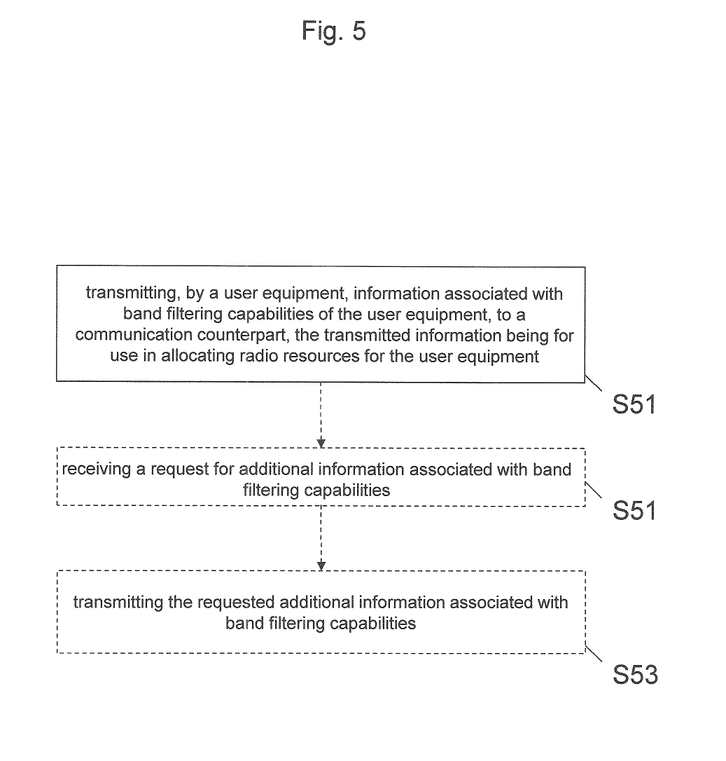

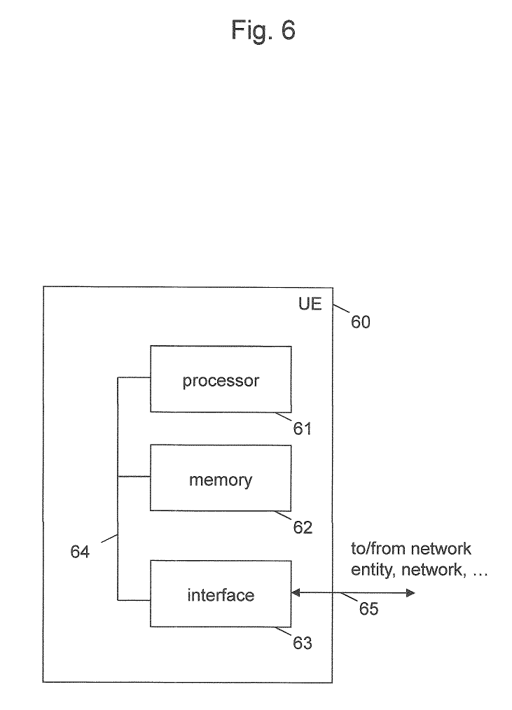

FIG. 5 shows a principle flowchart of a method according to embodiments of the present disclosure. That is, as shown in FIG. 5, this method comprises transmitting in a step S51, from a user equipment, information associated with filtering capabilities of the user equipment, to a communication counterpart. The UE determines this information itself in that the OF knows its own filtering capabilities.

According to embodiments of the present disclosure, the method further comprises receiving, at the user equipment in a step S52, a request for additional information associated with filtering capabilities from the communication counterpart, and transmitting, by the user equipment, the requested additional information associated with filtering capabilities to the communication counterpart, in a step S53.

According to embodiments of the present disclosure, transmitting the information comprises transmitting the information or the additional information directly from the user equipment to the communication counterpart or indirectly via a network.

According to embodiments of the present disclosure, the filtering capabilities of the user equipment are indicated using a predefined value.

According to embodiments of the present disclosure, if the user equipment uses a single filter covering a whole frequency hand, the filtering capabilities comprise information indicating that the filter covers the whole band or comprise no information.

According to embodiments of the present disclosure, if the filter used by the user equipment consists of two or more sub-band filters, the filtering capabilities comprise information about at least one or more sub-band pass-band edges, sub-band center frequency, or sub band filter band width.

According to embodiments of the present disclosure, the information about one or more sub-band pass-band edge is calculated from information about center frequencies, sub-band filter pass-band bandwidth or the like of the two or more sub-band filters.

According to embodiments of the present disclosure, if the pass band of the filter used in the user equipment is tunable in the frequency domain, the filtering capabilities comprise information associated with filter response tunability characteristics of the filter.

According to embodiments of the present disclosure, the communication counterpart comprises a network or a network entity. The network may for example comprise a wireless ad hoc network.

According to embodiments of the present disclosure, the method is implemented in a communication element located in an LTE or LTE-A based cellular communication network or in a 3m generation (3G) mobile communication network. In this case, the information is transmitted to a communication network control element, for example an evolved node B, of the LTE LTE-A based cellular communication network, or a base station in a 30 network controlling the communication element. Further information may be transmitted to alternate eNodeB base station/communication counterparts, which have a radio communication link with the UE.

FIG. 6 shows a principle configuration of an example for a user equipment according to embodiments of the present disclosure. One way to implement this example for a user equipment according to embodiments of the present disclosure would be a component in a handset such as user equipment UE according to LTE/LTE-A and/or HSPA (3G) (according to both FDD and TDD systems).

Specifically, as shown in FIG. 6, the example for a user equipment 60 comprises at least one processor 61 (or processing system), at least one memory 62 including computer program code and an interface 63 which are connected by a bus 64 or the like. The at least one memory and the computer program code are arranged to, with the at least one processor, cause the user equipment at least to perform transmitting information associated with filtering capabilities of the user equipment to a communication counterpart.

According to embodiments of the present disclosure, the at least one memory and the computer program code are further arranged to, with the at least one processor, cause the user equipment at least to perform receiving a request for additional information associated with filtering capabilities from the communication counterpart, and transmitting the requested additional information associated with filtering capabilities to the communication counterpart.

For further functions of the user equipment according to further embodiments of the present disclosure, reference is made to the above description of a method according to embodiments of the present disclosure, as described in connection with FIG. 5.

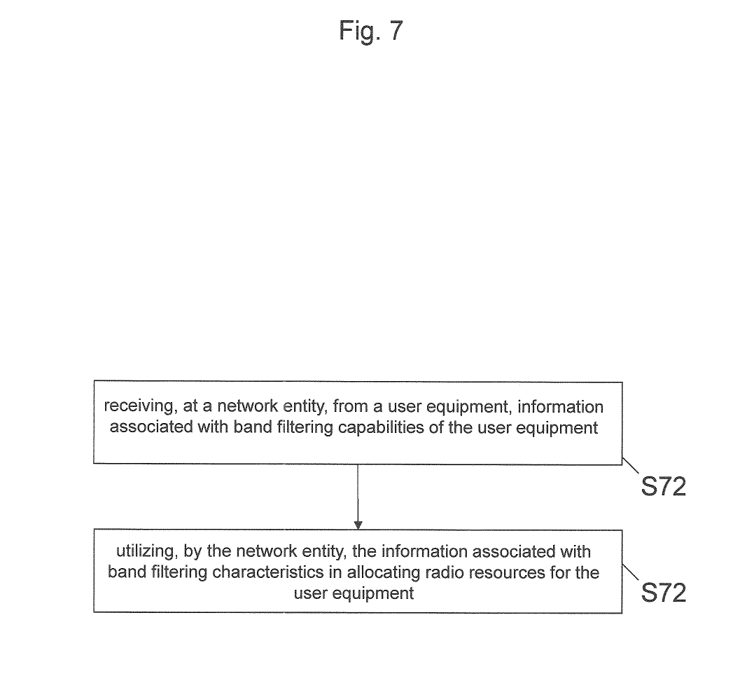

FIG. 7 shows a principle flowchart of another method according to embodiments of the present disclosure. That is, as shown in FIG. 7, this method comprises receiving, at a network entity in a step S71, from a user equipment, information associated with filtering capabilities of the user equipment, and utilizing, by the network entity in a step S72, the information associated with filtering capabilities in allocating radio resources for the user equipment.

It is noted that a network entity may be arranged with software, algorithms, and memories and information associated with filtering capabilities received from a UE may be processed with further information which is shared with the UE. This information may be for example an NS value to be indicated for UE.

According to embodiments of the present disclosure, the method farther comprises transmitting, from the network entity, a request for additional information associated with the filtering capabilities of the user equipment to the user equipment, receiving, at the network entity, the additional information associated with filtering capabilities from the user equipment, and utilizing, by the network entity, also the received additional information associated with filtering capabilities in allocating radio resources for the user equipment.

According to embodiments of the present disclosure, receiving the information comprises receiving the information or the additional information directly from the user equipment or indirectly via a network.

According to embodiments of the present disclosure, the filtering capabilities of the user equipment are indicated using a predefined value.

According to embodiments of the present disclosure, if the filter used by the user equipment is a single filter covering a whole frequency band, the filtering capabilities comprise information indicating that the filter covers the whole band or comprise no information.

According to embodiments of the present disclosure, if the filter used by the user equipment consists of two or more sub-band filters, the filtering capabilities comprise information about at least one or more sub-band pass-band edges, sub-band center frequency, or sub band filter band width.

According to embodiments of the present disclosure, the information about one of more sub-band pass-band edge is calculated from information about center frequencies, sub-band filter pass-band bandwidth or the like of the two or more sub-band filters.

According to embodiments of the present disclosure, if the pass-band of the filter used in the user equipment is tunable in the frequency domain, the filtering capabilities comprise information associated with filter response tunability characteristics of the filter.

According to embodiments of the present disclosure, the method is implemented in a communication network control element, for example an evolved node B, of an LTE or LTE-A based cellular communication network or a base station in a 3^{rd} generation mobile communication network. In such a case, information associated with filtering capabilities is received from and the request for additional information about the filtering capabilities is transmitted to a communication element being controlled by the communication network control element.

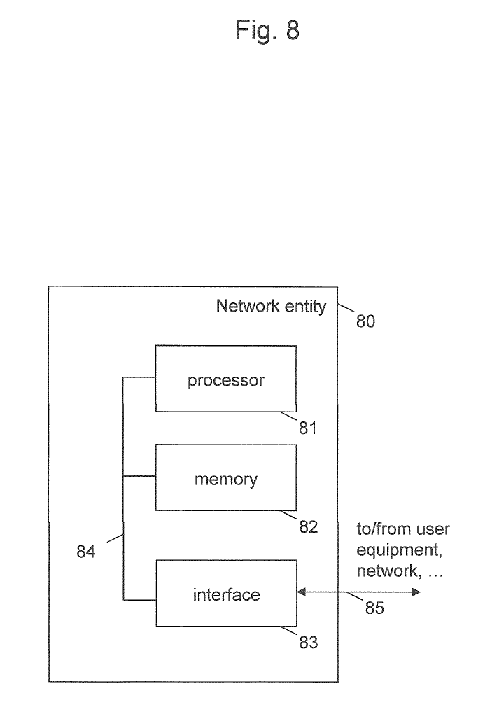

FIG. 8 shows a principle configuration of an apparatus according to embodiments of the present disclosure. One way to implement this apparatus according to embodiments of the present disclosure would be a base station in a 3G communication network or an eNB according to LTE/LTE A.

Specifically, as shown in FIG. 8, the apparatus 80, e.g. a base station or an eNB, comprises at least one processor 81 (or processing system), at least one memory 82 including computer program code, and an interface 83 which are connected by a bus 84 or the like. The at least one memory and the computer program code are arranged to, with the at least one processor, cause the apparatus at least to perform receiving, from a user equipment, information associated with filtering capabilities of the user equipment, and transmitting a request for additional information associated with the filtering capabilities.

It is noted that the memory 82 may also comprise computer special purpose program code or a special purpose algorithm. For example, an algorithm may determine NS value for UE accordingly for filters to be used in communication.

For further functions of the network entity according to further embodiments of the present disclosure, reference is made to the above description of a method according to embodiments of the present disclosure, as described in connection with FIG. 7.

in view of the above description of embodiments of the present disclosure, it is noted that filters may be duplexers, triplexers, diplexers, TX filters, RX filters, TDD filters, FDD filters, diversity receiver filters, MIMO receiver filters, MIMO transmitter filters, tunable filters, or the like.

In the foregoing description of the apparatuses, i.e. the user equipment and the network entity, only the units that are relevant for understanding the principles of embodiments have been described using functional blocks. The apparatuses may comprise further units that are necessary for its respective operation as user equipment or network entity, respectively. However, a description of these units is omitted in this specification. The arrangement of the functional blocks of the apparatuses is not construed to limit embodiments, and the functions may be performed by one block or further split into sub-blocks. Further, the apparatuses, i.e. the user equipment and the network entity, may be connected via a link 65/85. The link 65/85 may be a physical and/or logical coupling, which is implementation-independent (e.g. wired or wireless).

According to embodiments of the present disclosure, a system may comprise any conceivable combination of the thus depicted devices/apparatuses and other network elements, which are arranged to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any procedural step or functionality is suitable to be implemented as software or by hardware without changing principles of embodiments. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using thr example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, system in package (SIP), or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims,

### ABBREVIATIONS

3GPP The 3^{rd} Generation Partnership Project

APAC Asia-Pasific

A-MPR Additional Maximum Power Reduction

AXGP Advanced eXtended Global Platform

BW Bandwidth

CA Carrier Aggregation

CC Component Carrier

DL Downlink

eNB evolved Node-B

E-UTRA Evolved Universal Terrestrial Radio Access

FDD Frequency Division Duplex

IE information Element

IL Insertion Loss

IMD Intermodulation Distortion

LTE(-A) Long Term Evolution (Advanced)

MSS Mobile Station Signalling value

NF Noise Figure

RAT Radio Access Technology

RB Resource Block

RFIC Radio Frequency Integrated Circuit

RX Receiver

SW Software

TDD Time-Division Duplex

TRX Transceiver

TX Transmitter

UE User Equipment

UL Uplink

What is claimed is:

1. A method of controlling a user equipment, the method comprising, at the user equipment, transmitting to a communication counterpart information associated with band filtering capabilities of the user equipment,
wherein the transmitted information is for use in allocating radio resources for the user equipment.

2. A method according to claim, comprising, at the user equipment:
receiving a request for additional information associated with band filtering capabilities from the communication counterpart; and
transmitting the requested additional information associated with band filtering capabilities to the communication counterpart.

3. A method according to claim 1, wherein transmitting the information comprises transmitting the information or the additional information directly from the user equipment to the communication counterpart or indirectly via a network.

4. A method according to claim 1, wherein the band filtering capabilities of the user equipment are indicated using a predefined value.

5. A method according to claim 1, wherein the user equipment uses a single filter covering a whole frequency band, and the band filtering capabilities comprise information indicating that the filter covers the whole band or comprise no information.

6. A method according to claim 1, wherein the user equipment comprises two or more sub-band filters, and the band filtering capabilities comprise information associated with one or more of:
one or more sub-band pass-band edges,
sub-band center frequency, and
sub band filter band width.

7. A method according to claim 6, wherein the information associated with one or more sub-band pass-band edges is calculated from information associated with center frequencies or sub-band filter pass-band bandwidth of the two or more sub-band filters.

8. A method according to claim 1, wherein the pass-band of the filter used in the user equipment is tunable in the frequency domain, and the band filtering capabilities comprise information associated with one or more filter response tunability characteristics of the filter.

9. A method according to claim 1, wherein the communication counterpart comprises any one of a network, a network entity and a wireless ad hoc network.

10. A method according to claim 1, wherein the method is implemented in a communication element located in an LTE or LTE-A based cellular communication network or in a 3^{rd} generation mobile communication network.

11. A method of controlling a network entity, the method comprising, at the network entity:
receiving, from a user equipment, information associated with band filtering capabilities of the user equipment; and
utilizing the information associated with band filtering capabilities in allocating radio resources for the user equipment.

12. A method according to claim 11, further comprising, at the network entity:
transmitting, to the user equipment, a request for additional information associated with the band filtering capabilities of the user equipment;
receiving, from the user equipment, the additional information associated with band filtering capabilities; and
utilizing also the received additional information associated with band filtering capabilities in allocating radio resources for the user equipment.

13. A method according to claim 11, wherein receiving the information comprises receiving the information or the additional information directly from the user equipment or indirectly via a network.

14. A method according to claim 11, wherein the band filtering capabilities of the user equipment are indicated using a predefined value.

15. A method according to claim 11, wherein the filter used by the user equipment comprises a single filter covering a whole frequency band, and the band filtering capabilities comprise information indicating that the filter covers the whole band or comprise no information.

16. A method according to claim 11, wherein the filter used by the user equipment comprises two or more sub-band filters, and the band filtering capabilities comprise information associated with one or more of:
one or more sub-band pass-band edges,
sub-band center frequency, and
sub band filter band width.

17. A method according to claim 16, wherein the information associated with one of more sub-band pass-band edges is calculated from information associated with center frequencies or sub-band filter pass-band bandwidth of the two or more sub-band filters.

18. A method according to claim 11, wherein the pass-band of the filter used in the user equipment is tunable in the frequency domain, and the band filtering capabilities comprise information associated with one or more filter response tunability characteristics of the filter.

19. A method according to claim 11, wherein the method is implemented in a communication network control element of an LTE or LTE-A based cellular communication network or a base station in a 3^{rd} generation mobile communication network.

20. Apparatus for use in controlling a user equipment, the apparatus comprising at least one processor, and at least one memory including computer program code, the at least one memory and the computer program code being configured, with the at least one processor, to cause the apparatus at least to transmit information associated with band filtering capabilities of the user equipment to a communication counterpart,
wherein the transmitted information is for use in allocating radio resources for the user equipment.

21. Apparatus, for use in controlling a network entity, the apparatus comprising at least one processor, and at least one memory including computer program code, the at least one memory and the computer program code being configured, with the at least one processor, to cause the apparatus at least to:
receive, from a user equipment, information associated with band filtering capabilities of the user equipment; and
utilize the information associated with band filtering capabilities in allocating radio resources for the user equipment.
